(19) United States
(12) Patent Application Publication
(10) Pub. No.: US 2012/0072584 A1
(43) Pub. Date: Mar. 22, 2012

(54) COMPUTER PRODUCT, MANAGEMENT APPARATUS, AND MANAGEMENT METHOD

(75) Inventor: Kunihiko KASSAI, Kawasaki (JP)

(73) Assignee: Fujitsu Limited, Kawasaki-shi (JP)

(21) Appl. No.: 13/166,884

(22) Filed: Jun. 23, 2011

(30) Foreign Application Priority Data
Sep. 22, 2010 (JP) 2010-212836

(51) Int. Cl. G06F 15/173

(52) U.S. Cl. 709/224

(57) ABSTRACT

A computer-readable, non-transitory medium stores therein a management program that causes a computer to execute a procedure. The procedure includes detecting an increase in access frequency of a first apparatus by a second apparatus; changing a first process of acquiring from the first apparatus and independently for each access of the first apparatus by the second apparatus, information indicating access particulars, to a second process of collectively acquiring from the first apparatus, the information indicating access particulars, if an increase in the access frequency is detected at the detecting; and acquiring the information indicating access particulars, where the information indicating access particulars is acquired independently according to the first process, and is acquired collectively according to the second process, after the first process is changed to the second process at the changing.

### CROSS REFERENCE TO RELATED APPLICATIONS

This application is based upon and claims the benefit of priority of the prior Japanese Patent Application No. 2010-212836, filed on Sep. 22, 2010, the entire contents of which are incorporated herein by reference.

### FIELD

The embodiment discussed herein is related to managing the access state of an accessed apparatus.

### BACKGROUND

Recently, a multitude of systems are in use that realize the sharing of data among multiple users and terminals, through networks. As a network, various configurations are provided, for example an external network such as the Internet or an internal network such as a local area network (LAN) may be used. Irrespective of the network used, data shared by multiple users or terminals is often stored in a data storage apparatus having a specialized function of storing data, such as a file server.

Typically, data stored in a data storage apparatus is not managed by the terminals or users that use the stored data, but rather by a dedicated management apparatus or software that implements a function comparable to a management apparatus. For example, a management apparatus sets access authorization, manages file information and utilization, for a folder created in a memory area of a data storage apparatus (for example, see Japanese Laid-Open Patent Publication No. 2009-276969).

The setting of access authorization is a process of determining whether a terminal connected to the network is permitted to access a data storage apparatus. File information management is a process of knowing at a file-level, what data is stored in the data storage apparatus. For example, the management apparatus acquires for each file, information concerning the file format, file size, update state, etc. to know the contents of the file. Utilization management is a process of designating areas that can be used for data storage in the data storage apparatus and specifying among the usable areas, areas to which data has been stored (for example, see Japanese Laid-Open Patent Publication No. H10-513592).

Management of the data storage state and access state of the data storage apparatus performed by the management apparatus can be useful in the analysis of the operation state of a system by a manager and in identifying the cause when an error occurs. To manage the data storage state and access state, the management apparatus acquires from the data storage apparatus, information related to access particulars (for example, see Japanese Laid-Open Patent Publication No. 2004-310357).

Normally, each time the data storage apparatus is newly accessed, the management apparatus acquires log information indicating access particulars. However, even if the data storage apparatus is frequently accessed, the log information is acquired for each access, whereby the amount of processing by the management apparatus becomes tremendous. Thus, technology has been disclosed that preliminary and periodically analyzes load changes of the management apparatus and network according to the number of times the data storage apparatus is accessed and based on the analysis results, performs a survey during periods of low load, to get an understanding of access particulars (for example, see Japanese Laid-Open Patent Publication No. 2006-268594).

However, in the case of such conventional technologies, there is a problem of large changes in the processing load of the management apparatus consequent to changes in the number of times an apparatus is accessed (e.g., a data storage apparatus) by another apparatus. When an apparatus is accessed by another apparatus, conventional management apparatuses perform surveys to get an understanding of access particulars with respect to all files created in the accessed apparatus.

Further, each time the number of accesses increases, heavy-load processing, i.e., the surveying of all files, is performed. However, the files that have actually been altered (newly created, updated, deleted, etc.) consequent to access are but a portion of the total files. In other words, the conventional processing of surveying all files is extremely inefficient. In addition, since the amount of processing is tremendous, the processing speed of the management apparatus with respect to updating access particulars decreases. As a result, the access particulars understood by the management apparatus and the data actually stored in the accessed apparatus are inconsistent, potentially compromising real-timeliness.

Further, the apparatuses and the management apparatus constituting the system are respectively connected through a network. In other words, each time a communication process where an apparatus is accessed by another apparatus, a communication process to know the access particulars is performed between the management apparatus and the accessed apparatus. Therefore, a problem arises in that consequent to increased access, the telecommunication lines related to the accessed apparatus become busy and the communication speed decreases.

As an example of conventional technology, although technology has been disclosed where changes in the number of past accesses is preliminarily analyzed and a survey is performed during a low-load period to know the access particulars, for a system in which the number of accesses does not change cyclically, it is likely that sufficient results cannot be obtained. Therefore, a problem arises in that unless changes in the number of accesses occur as expected, concentrated loads on the management apparatus consequent to the increase in access cannot be relieved.

### SUMMARY

According to an aspect of an embodiment, a computer-readable, non-transitory medium stores therein a management program that causes a computer to execute a procedure. The procedure includes detecting an increase in access frequency of a first apparatus by a second apparatus; changing a first process of acquiring from the first apparatus and independently for each access of the first apparatus by the second apparatus, information indicating access particulars, to a second process of collectively acquiring from the first apparatus, the information indicating access particulars, if an increase in the access frequency is detected at the detecting; and acquiring the information indicating access particulars, where the information indicating access particulars is acquired independently according to the first process, and is acquired collectively according to the second process, after the first process is changed to the second process at the changing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic depicting one example of management processing according to the present embodiment.

FIG. 2 is a block diagram of a system configuration of the present embodiment.

FIG. 3 is a block diagram of a hardware configuration of a management apparatus.

FIG. 4 is a block diagram of a functional configuration of the management apparatus.

FIG. 5 is a data table depicting an example of a data configuration of a management table.

FIG. 6 is a diagram depicting one example of log information.

FIG. 7 is a flowchart of a procedure of changing an information acquisition process in the management apparatus.

FIG. 8 is a flowchart of a procedure of survey method switching.

FIG. 9 is a diagram depicting an example of access concentration in a file server.

FIG. 10 is a flowchart of a procedure of setting a survey target.

FIG. 11 is a flowchart of a procedure of a log survey process.

FIG. 12 is a flowchart of a procedure of a state displaying process.

FIG. 13 is a flowchart of a procedure of adjusting a surveying interval.

### DESCRIPTION OF EMBODIMENTS

Preferred embodiments of the present invention will be explained with reference to the accompanying drawings.

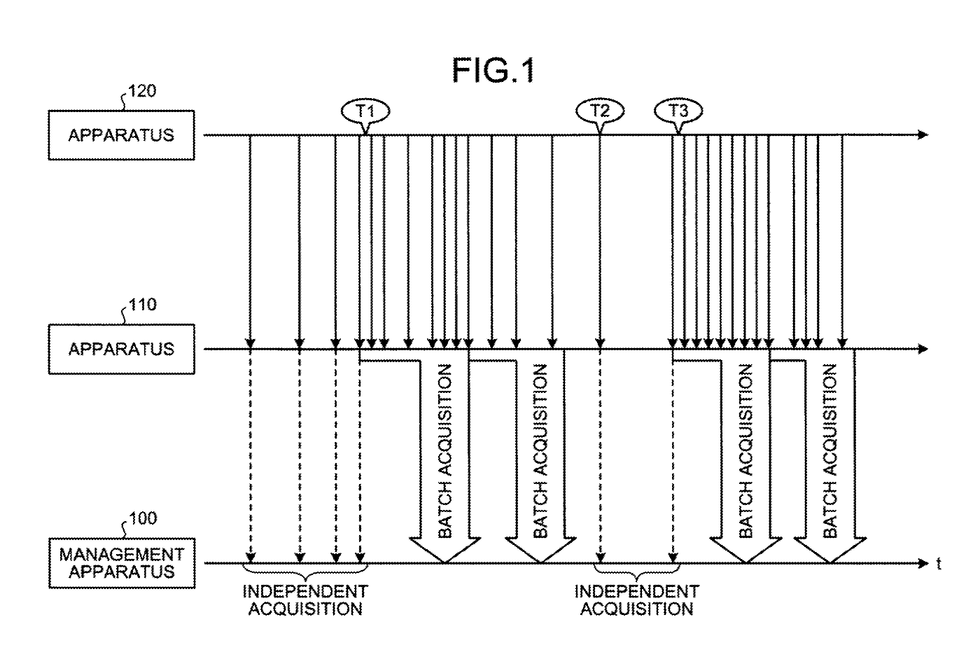

FIG. 1 is a schematic depicting one example of management processing according to the present embodiment. As depicted in FIG. 1, in the present embodiment, a management apparatus 100 surveys the update state of an apparatus 110 that is accessed. For example, the management apparatus 100 acquires from the apparatus 110, update information indicating access particulars for the apparatus 110. Access particulars are processes, such as “newly creating, updating, and deleting” a file or folder, performed by an apparatus 120 with respect to the accessed apparatus 110.

In FIG. 1, arrows from the apparatus 120 toward the apparatus 110 (↓) each indicate access (newly creating, updating, deleting, etc.). Arrows from the apparatus 110 toward the management apparatus 100 respectively indicate acquisitions of update information by the management apparatus 100.

In the case of the management processing according to the present embodiment, when the management apparatus 100 acquires update information from the apparatus 110, one of two types of information acquiring processes is adopted, “independent acquisition” and “batch acquisition”.

Independent acquisition is a process in which the management apparatus 100 acquires update information from the apparatus 110, independently for each access of the apparatus 110 by the apparatus 120. Update information acquired by independent acquisition corresponds to the dotted-lined arrows among the arrows in FIG. 1, originating from the apparatus 110 and directed toward the management apparatus 100. In independent acquisition, since update information is acquired at each access and although the amount of update information for one execution of the acquisition process is small, the acquisition process has to be executed for a number of times equivalent to the number of accesses.

Batch acquisition is a process in which the management apparatus 100 collectively acquires all of the update information for accesses to the apparatus 110 by the apparatus 120 during a given interval. Update information acquired by batch acquisition corresponds to the wide arrows among the arrows in FIG. 1, originating from the apparatus 110 and directed toward the management apparatus 100. In batch acquisition, since update information is collectively acquired for each specified timing, although the amount of update information for one execution of the acquisition process is large, compared to independent acquisition, the number of times that the acquisition has to be executed is significantly less.

The management apparatus 100 detects variations in the frequency of access to the apparatus 110 (number of accesses per unit time). Triggered by a detection of an increase or a decrease in the access frequency, the management apparatus 100 switches the acquisition process to independent acquisition or batch acquisition.

For example, in the case of the example depicted in FIG. 1, the management apparatus 100 has been set to perform independent acquisition. Subsequently, the management apparatus 100 determines that at timing T1, the access frequency has increased, whereby the management apparatus 100, at the border of T1, switches the information acquisition process for the update information, from independent acquisition to batch acquisition.

Thereafter, the access frequency continues to be high and the management apparatus 100 continues to perform batch acquisition. At timing T2, the management apparatus 100 determines that the access frequency has decreased, whereby the management apparatus 100, at the border of T2, switches the information acquisition process for the update information from batch acquisition to independent acquisition. Similarly, the management apparatus 100, at timing T3, detects an increase in the access frequency, whereby the management apparatus 100, at the border of T3, switches the information acquisition process for the update information, from independent acquisition to batch acquisition.

As described, in the case of the management process according to the present embodiment, the management apparatus 100 can switch the information acquisition process for the update information, based on changes in the frequency of access to the apparatus 110. Therefore, even if access of the apparatus 110 by the apparatus 120 becomes concentrated, since the management apparatus 100 reduces the processing load for the managing the updating state, the management apparatus 100 can prevent decreases in processing performance.

Hereinafter, a system configuration for implementing the management process described in FIG. 1, a configuration of and operation of the management apparatus will be described.

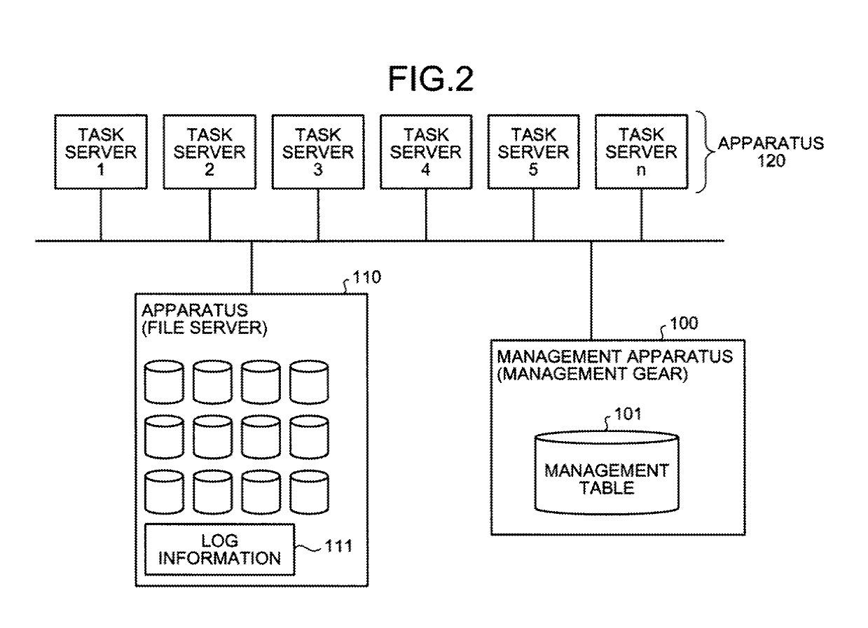

FIG. 2 is a block diagram of a system configuration of the present embodiment. As depicted in FIG. 2, in the present embodiment, the management apparatus 100 manages the updating state of the apparatus 110 in the system. A dedicated apparatus having a specialized function implementing the management processing according to the present embodiment or software implementing on a general purpose computer, the management processing according to the present embodiment may be used for the management apparatus 100.

A management table 101 is prepared in the management apparatus 100. The management apparatus 100 aggregates in the management table 101, the update information acquired from the accessed apparatus (file server) 110.

In FIG. 2 and hereinafter, an example of a file server will be described as the apparatus 110. Implementation of the apparatus 110 is not particularly limited although the apparatus is assumed to be accessed by a multiplicity of the apparatuses 120. Log information 111 is accumulated in the apparatus 110. The log information 111 is information indicating the particulars of access by each apparatus 120.

Similarly, in FIG. 2 and hereinafter, an example will be described in which the file server is accessed by and task data stored therein is shared by task servers 1-n, as the apparatus 120. Each task server may be prepared as a server dedicated for use by a specific user or may be prepared as a server for use by multiple users. If the server is to be used by multiple users, operation that enables the user who is using the server to be identified is preferable.

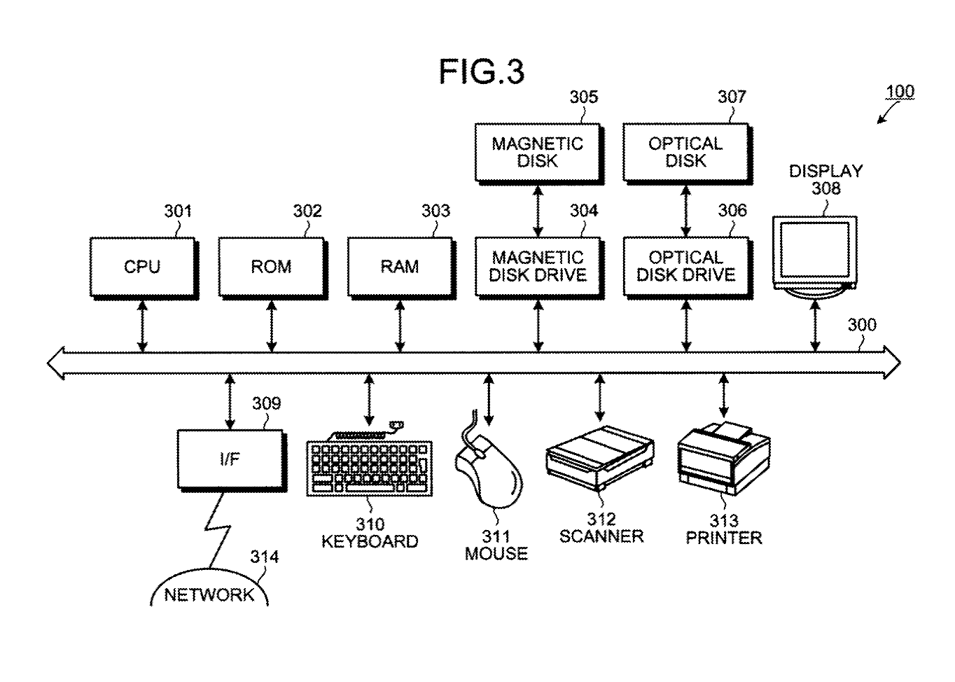

FIG. 3 is a block diagram of a hardware configuration of the management apparatus. As depicted in FIG. 3, the management apparatus 100 includes a central processing unit (CPU) 301, a read-only memory (ROM) 302, a random access memory (RAM) 303, a magnetic disk drive 304, a magnetic disk 305, an optical disk drive 306, an optical disk 307, a display 308, an interface (I/F) 309, a keyboard 310, a mouse 311, a scanner 312, and a printer 313, respectively connected by a bus 300.

The CPU 301 governs overall control of the management apparatus 100. The ROM 302 stores therein various types of programs such as a boot program and management programs for implementing the management processing according to the present embodiment. The RAM 303 is used as a work area of the CPU 301. The magnetic disk drive 304, under the control of the CPU 301, controls the reading and writing of data with respect to the magnetic disk 305. The magnetic disk 305 stores therein data written under control of the magnetic disk drive 304.

The optical disk drive 306, under the control of the CPU 301, controls the reading and writing of data with respect to the optical disk 307. The optical disk 307 stores therein data written under control of the optical disk drive 306, the data being read by a computer.

The display 308 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 308.

The I/F 309 is connected to a network 314 such as a local area network (LAN), a wide area network (WAN), and the Internet through a communications line and is connected to other apparatuses through the network 314. The I/F 309 administers an internal interface with the network 314 and controls the input/output of data from/to external apparatuses. For example, a modem or a LAN adaptor may be employed as the I/F 309.

The keyboard 310 includes, for example, keys for inputting letters, numerals, and various instructions and performs the input of data. Alternatively, a touch-panel-type input pad or numeric keypad, etc. may be adopted. The mouse 311 is used to move the cursor, select a region, or move and change the size of windows. A track ball or a joy stick may be adopted provided each respectively has a function similar to a pointing device.

The scanner 312 optically reads an image and takes in the image data into the management apparatus 100. The scanner 312 may have an optical character reader (OCR) function as well. The printer 313 prints image data and text data. The printer 313 may be, for example, a laser printer or an ink jet printer.

The hardware configuration of the management apparatus 100 as depicted in FIG. 3 is one example and for the sake of convenience, is preferable. Therefore, all of the hardware depicted in FIG. 3 need not be prepared, it is sufficient to include the minimal hardware necessary to implement the processing desired by the user of the management apparatus 100, i.e., according to the contents of the processing executed by the management apparatus 100, the CPU 301, the ROM 302, and the RAM 303.

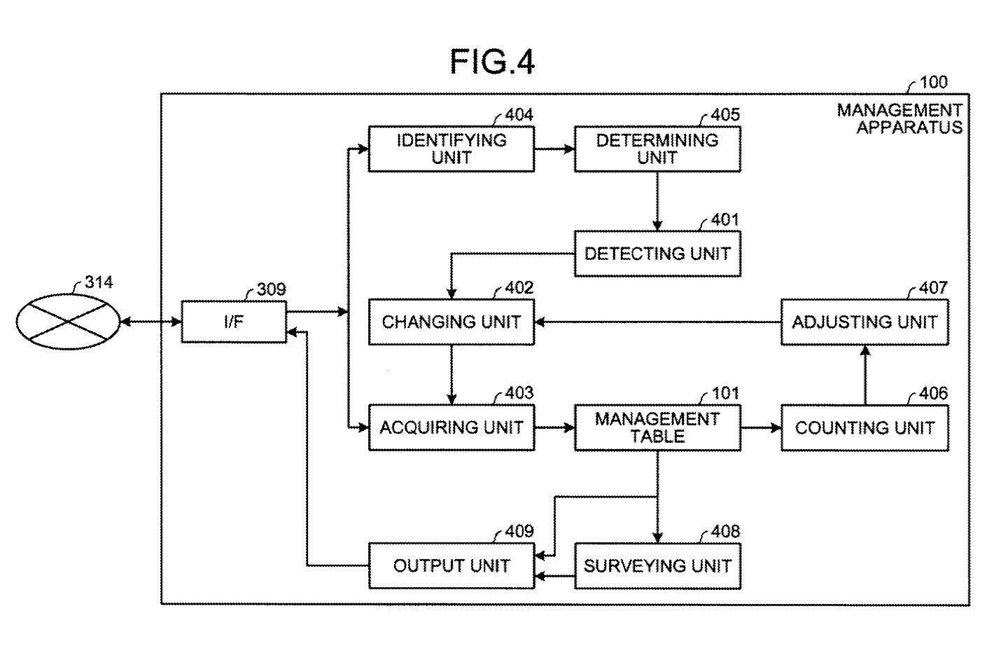

FIG. 4 is a block diagram of a functional configuration of the management apparatus. The management apparatus 100, as functional units to implement the management processing, includes a detecting unit 401, a changing unit 402, an acquiring unit 403, an identifying unit 404, a determining unit 405, a counting unit 406, an adjusting unit 407, a surveying unit 408, and an output unit 409. Functions forming a control unit (the detecting unit 401 to the output unit 409), for example, are implemented by executing on the CPU 301 or by the I/F 309, a program stored in a storage device, such as the ROM 302, the RAM 303, the magnetic disk 305, and the optical disk 307 depicted in FIG. 3.

Although the management apparatus 100 in FIG. 4 connects to the network 314 via the I/F 309, depending on the system configuration, the network 314 may be a global network or a local network.

The detecting unit 401 has a function of detecting changes in the frequency that the apparatus 110 is accessed by the apparatus 120. For example, via the I/F 309 and from the network, the detecting unit 401 detects changes in access frequency, i.e. changes in the frequency that the apparatus 110 is accessed by the apparatus 120. Changes in access frequency include increases and decreases.

Although the detecting unit 401 can acquire directly from the network 314, information indicating an increase or a decrease in access frequency, there may be cases where the detecting unit 401 acquires from the network 314, an access count of the number of times that the apparatus 110 is accessed by the apparatus 120. In such a case, functions of the identifying unit 404 and the determining unit 405, described hereinafter, may be used to detect changes in access frequency. Detection results obtained by the detecting unit 401 are stored to a storage device, such as the RAM 303, the magnetic disk 305, and the optical disk 307.

The changing unit 402 has a function of changing the process of acquiring update information from the apparatus 110. For example, the changing unit 402 controls the acquiring unit 403, described hereinafter, to change the process of acquiring update information from independent acquisition to batch acquisition, or from batch acquisition to independent acquisition.

For example, if independent acquisition has been set and the detecting unit 401 detects an increase in access frequency, the changing unit 402 changes the process from independent acquisition to batch acquisition. On the contrary, if batch acquisition has been set and the detecting unit 401 detects a decrease in access frequency, the changing unit 402 changes the process from batch acquisition to independent acquisition. The process changes are stored to a storage device such as the RAM 303, the magnetic disk 305, and the optical disk 307.

The acquiring unit 403 has a function of acquiring from the apparatus 110, update information indicating access particulars. For example, based on the information acquisition process changed to by the changing unit 402, the acquiring unit 403 acquires the update information.

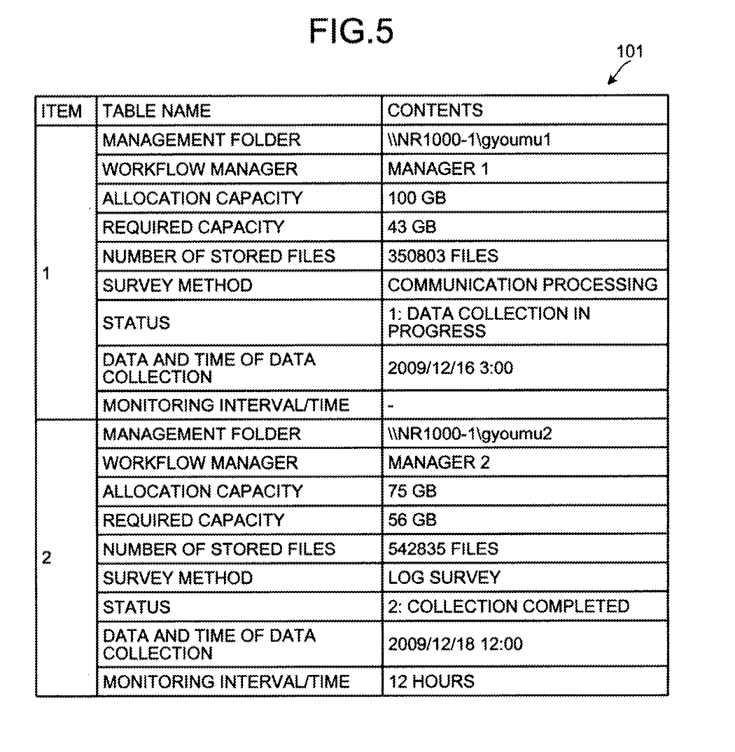

For example, as an initial setting, the management apparatus 100 sets the acquiring unit 403 to execute independent acquisition and subsequently, the acquiring unit 403 may be set by the changing process performed by the changing unit 402, to perform batch acquisition or to continue independent acquisition, depending on access frequency. Further, the update information acquired by the acquiring unit 403 is reflected in the management table 101 as depicted in the example in FIG. 5 described next.

FIG. 5 is a data table depicting an example of a data configuration of the management table. FIG. 5 is an example of a data configuration of the management table 101. The management table 101 is configured by fields such as those depicted in the example of FIG. 5, where the fields are provided for each item (1, 2, . . . ). Although in principle, the management table 101 has a configuration equivalent to a typical management table, in the management table 101, “survey method” and “monitoring interval/time” are prepared as fields for the information acquisition process switching, a table configuration unique to the management apparatus 100.

If the acquiring unit 403 is set for batch acquisition, since the log information 111 of the apparatus 110 is surveyed, the survey method is set as “log survey”. Further, if the acquiring unit 403 is set for independent acquisition, since update information communicated in real-time from the apparatus 110 is acquired, the survey method is set as “communication processing”. Moreover, if “log survey” is set, a monitoring interval or time is further set in the “monitoring interval/time” field, as the timing for the management apparatus 100 to acquire the log information 111.

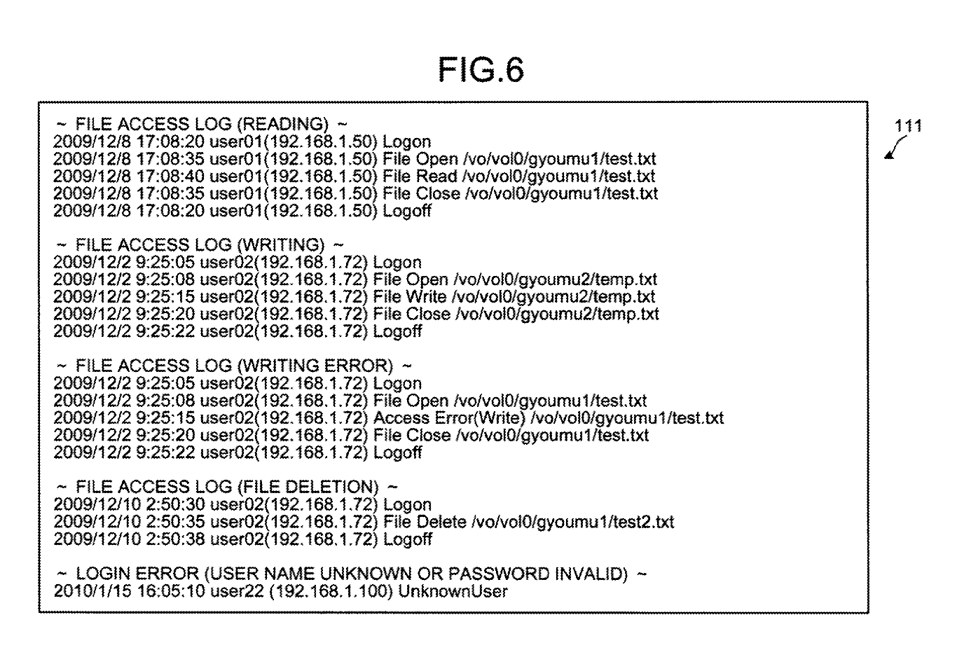

FIG. 6 is a diagram depicting one example of log information. As depicted in FIG.6, in the log information 111, information is accumulated that indicates for each access of the apparatus 110 by the apparatus 120, which file, at what time, and what type of processing was performed.

Aside from the control by the changing unit 402, if a display instruction instructing display of the management table 101 is received from a user of the management apparatus 100 or an upper level program, the acquiring unit 403 forcibly performs batch acquisition, if batch acquisition is currently set.

Normally, batch acquisition is performed at given intervals. However, if a display instruction for the management table 101 is received, the management apparatus 100 must display the management table 101 reflecting the access state up to the present. In the case of batch acquisition, at any time other than immediately after acquisition of the update information, the management table 101 does not reflect the latest update information. Therefore, if a display instruction for the management table 101 is received from the user of the management apparatus 100 or from an upper level program, the acquiring unit 403 forcibly performs batch acquisition as irregular processing. Consequently, the management apparatus 100 is able to display the management table 101 reflecting the latest update information.

Reference of the description returns to FIG. 4. The identifying unit 404 and the determining unit 405, as described above, are used if, based on the access count, the detecting unit 401 detects changes in access frequency. For example, the identifying unit 404 identifies the number of times the apparatus 110 is accessed by the apparatus 120 (access count) per unit time. The determining unit 405 determines whether the access count identified by the identifying unit 404 is less than a threshold.

For example, if the determining unit 405 determines that the access count is not less than the threshold, the detecting unit 401 detects an increase in the access frequency. On the contrary, if the determining unit 405 determines that the access count is less than the threshold, the detecting unit 401 detects a decrease in the access frequency. Details of the identification by the identifying unit 404 and determination results obtained by the determining unit 405 are stored to a storage device such as the RAM 303, the magnetic disk 305, and the optical disk 307.

The counting unit 406 has a function of counting the number of blocks of information included in update information acquired by the batch acquisition. The adjusting unit 407 has a function of adjusting the interval for performing batch acquisition. For example, according to the number of blocks of information counted by the counting unit 406, the adjusting unit 407 lengthens or shortens a given interval.

For example, if the number of blocks of information obtained as the update information is high, the timing (the length of the given interval) for performing batch acquisition is shortened. On the contrary, if the number of blocks of information is low, the timing for performing batch acquisition is lengthened. By the adjustment of the batch acquisition timing by the adjusting unit 407, the volume of update information obtained by batch acquisition is equalized, enabling processing load when access concentrates to be reduced.

The surveying unit 408 has a function of using the information stored to the management table 101 to survey items specified by the user. For example, the surveying unit 408 surveys “the number of files, the average access count, the time of the last update, etc.” of each folder. Survey results are stored to a storage device such as the RAM 303, the magnetic disk 305, and the optical disk 307.

The output unit 409 has a function of outputting specified information according to an instruction from a user or upper level program. For example, the output unit 409 outputs the storage contents of the management table 101 and the survey results obtained by the surveying unit 408. Examples of forms of output include display at the display 308, print out at the printer 313, and transmission to an external device via the I/F 309. In particular, if an output instruction is received from the apparatus 120, the output unit 409 outputs the specified information via the I/F 309. Furthermore, the specified information may be stored to a storage device such as the RAM 303, the magnetic disk 305, and the optical disk 307.

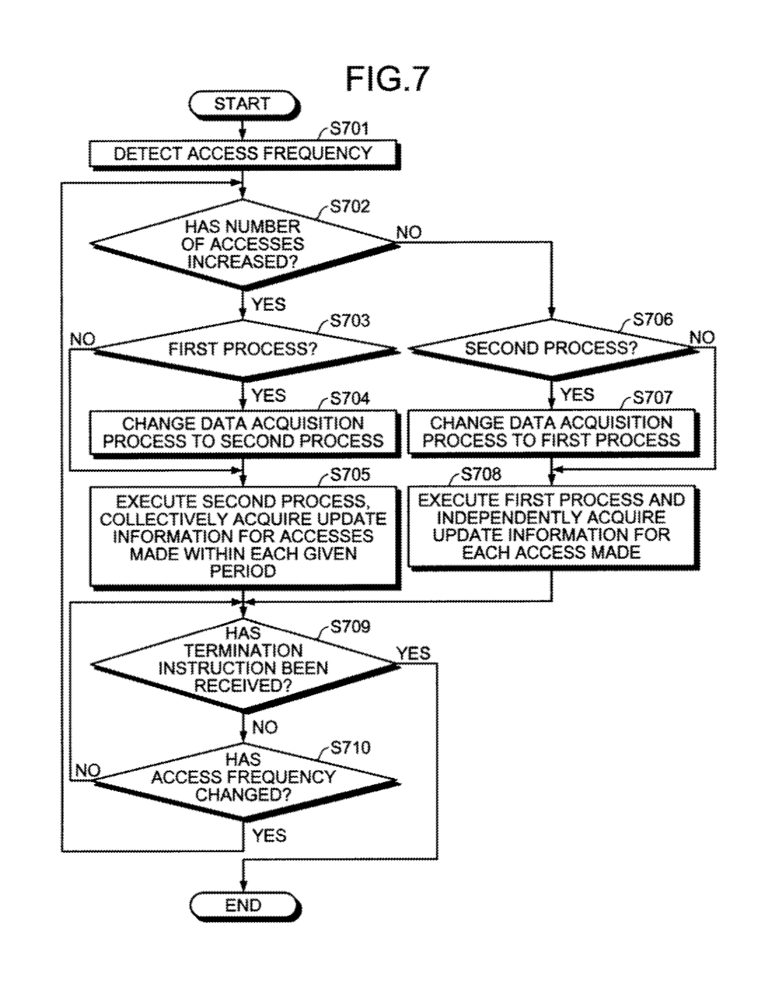

FIG. 7 is a flowchart of a procedure of changing the information acquisition process in the management apparatus. The flowchart in FIG. 7 depicts a procedure of changing, based on access frequency detection results, the process of acquiring information from the apparatus 110 by the management apparatus 100. By executing each of the processes in FIG. 7, the management apparatus 100 is able to prevent situations where communication processes with the apparatus 110 concentrate. In the description hereinafter, for the sake of convenience, independent acquisition is referred to as “first process” and batch acquisition is referred to as “second process”.

In the flowchart in FIG. 7, the management apparatus 100, via the detecting unit 401, detects the access frequency (step S701). The management apparatus 100, based on the access frequency detected by the detecting unit 401, determines whether the access count for the apparatus 110 has increased (step S702).

At step S702, if it is determined that the access count for the apparatus 110 has increased (step S702: YES), the management apparatus 100 transitions to processing to reduce the load required for the information acquisition process of acquiring the update information from the apparatus 110.

For example, the management apparatus 100 sets the acquiring unit 403 to perform the second process of collectively acquiring from the log information 111, the update information indicating each access of the apparatus 110 by the apparatus 120. Therefore, the management apparatus 100 determines whether the acquiring unit 403 is currently set to perform the first process (step S703).

At step S703, if it is determined that the acquiring unit 403 is set to perform the first process (step S703: YES), the management apparatus 100 has to change the information acquisition process by the acquiring unit 403, to a low-load process. Therefore, the management apparatus 100 changes the information acquisition process of the acquiring unit 403, from the first process to the second process (step S704).

On the other hand, at step S703, if it is determined that the acquiring unit 403 is not set to perform the first process (step S703: NO), the acquiring unit 403 is already set to perform the second process and therefore, the management apparatus 100 transitions to the process at step S705, without performing the process at step S704.

The management apparatus 100 performs the second process, which is currently set (step S705). For example, at step S705, the management apparatus 100, via the acquiring unit 403, collectively acquires for each given interval, the update information for the accesses occurring during the interval. The update information is obtained by extracting from the log information 111 accumulated in the apparatus 110, information related to the accesses that occurred during a given interval.

At step S702, if it is determined that the access count for the apparatus 110 has not increased (step S702: NO), the management apparatus 100 does not have to reduce the load required for the process of acquiring the update information from the apparatus 110. Thus, each time the apparatus 120 accesses the apparatus 110, the management apparatus 100 transitions to a process for setting the acquiring unit 403 to acquire update information related to the access.

The management apparatus 100 confirms whether the acquiring unit 403 is currently set for the second process (step S706). At step S706, if it is determined that the acquiring unit 403 is set for the second process (step S706: YES), the management apparatus 100 changes the information acquisition process of the acquiring unit 403 from the second process to first process (step S707).

On the other hand, at step S706, if it is determined that the acquiring unit 403 is not set for the second process (step S706: NO), the acquiring unit 403 is already set for the first process and therefore, the management apparatus 100 transitions to the process at step S708, without performing the process at step S707.

The management apparatus 100 performs the first process, which is currently set (step S708). For example, at step S708, the management apparatus 100, via the acquiring unit 403 independently acquires update information, for each access of the apparatus 110 (step S708).

Thereafter, the management apparatus 100 determines whether a termination instruction for management processing has been received (step S709). Normally, since the management apparatus 100 manages the updating state of the apparatus 110, the management apparatus 100 is continuously in operation. However, if the management apparatus 100 receives a termination instruction from an upper level program or manager, the management apparatus 100 terminates operation. Therefore, at step S709, if it is determined that a termination instruction for the management processing has been received (step S709: YES), the management apparatus 100 ends the series of processes.

At step S709, if it is determined that a termination instruction has not been received (step S709: NO), the management apparatus 100 determines whether the access frequency has changed (step S710). At step S710, if the access frequency has changed (step S710: YES), the management apparatus 100 returns to the process at step S702 and continues to change the setting of information acquisition process according to the access frequency.

On the other hand, at step S710, if it is determined that the access frequency has not changed (step S710: NO), since there is no need to changed the information acquisition process currently set, the management apparatus 100 returns to the process at step S709. Therefore, once the management apparatus 100 sets the information acquisition process, the management apparatus 100 waits until a change in the access frequency is detected or a termination instruction is received.

As described, in the present embodiment, the update state of the apparatus 110 is managed by the management apparatus 100. The management apparatus 100 can change the process to acquire the update information for understanding the update state, according to the frequency that the apparatus 110 is accessed by the apparatus 120. Therefore, the management apparatus 100 can prevent a situation in which the load of the information acquisition process significantly increases when access of the apparatus 110 is concentrated.

Next, according to a function of a file server implementing the apparatus 110, an application example of the management apparatus 100 will be described. First, a function of the file server will be described. When the file server is accessed by the apparatus 120, the file server successively notifies the management apparatus 100 of update information that indicates the access particulars. In other words, file server is normally set to execute independent acquisition. Therefore, if batch acquisition is to be executed with respect to the file server, the management apparatus 100 has to preliminarily give an instruction to terminate the successive notification.

Hereinafter, processes of the management apparatus 100 of the above file server having the functions of successively given notification and implementing the apparatus 110 will be described.

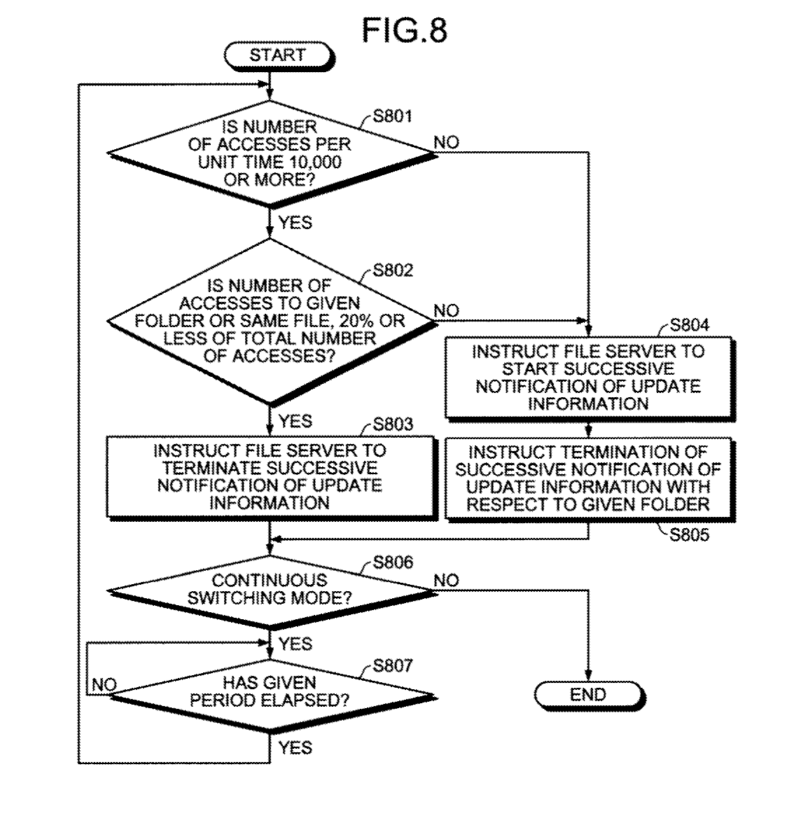

FIG. 8 is a flowchart of a procedure of survey method switching. FIG. 8 depicts a procedure performed by the management apparatus 100 to notify the file server, which is the apparatus 110, to start or terminate successive notification according to variations in the access count. By executing each of the processes in FIG. 8, the successive notification function of the file server can be controlled, according to the access state.

In FIG. 8, the management apparatus 100 determines whether the number of accesses per unit time (for example, an initial interval of 10 minutes) is at least 10,000 (step S801). At step S801, 10,000 is used as one example of a criterion for making the determination that the access count has increased. Therefore, the access count used as a criterion can be set according to the number of the apparatuses 120, the overall scale of the system, etc.

At step S801, if the access count is determined to be 10,000 or more (step S801: YES), the management apparatus 100 determines whether the access count for a given folder (or the same file) is at most 20 percent of the total number of accesses (step S802). Step S802 is a process for determining whether access is concentrating at a given folder (or the same file).

At step S802, if it is determined that the access count for the given folder (or the same file) is 20 percent or less of the total access count (step S802: YES), the management apparatus 100 determines that access is not concentrating at the given folder (or the same file). Therefore, the management apparatus 100 instructs the file server to terminate successive notification of the update information (step S803).

On the other hand, at step S801, if it is determined that the access count per unit time is not 10,000 or more (step S801: NO), the management apparatus 100 determines that the access count is not increasing. Further, at step S802, if it is determined that the access count for the given folder (or the same file) is not 20 percent or less of the total access count (step S802: NO), the management apparatus 100 determines that access is concentrating at the given folder (or the same file).

Therefore, the management apparatus 100 instructs the file server to start successive notification of the update information (step S804). Further, the management apparatus 100 instructs the file server to terminate successive notification of the update information with respect to the given folder (step S805).

When the process at step S803 or step S805 ends, the management apparatus 100 determines whether the mode is a continuous switching mode (step S806). The continuous switching mode is a mode of continuously executing the respective processes at steps S801 to S805.

At step S806, if it is determined that the continuous switching mode is set (step S806: YES), the management apparatus 100 determines whether a given interval has elapsed since the end of the notification process at step S803 or step S805 (step S807). At step S806, if it is determined that the continuous switching mode is not set (step S806: NO), the management apparatus 100 ends the series of processes.

At step S807, the management apparatus 100 waits for the given interval to elapse (step S807: NO). Thereafter, when it has been determined that the given interval has elapsed (step S807: YES), the management apparatus 100 transitions to the process at step S801 and again, performs the determination at step S801.

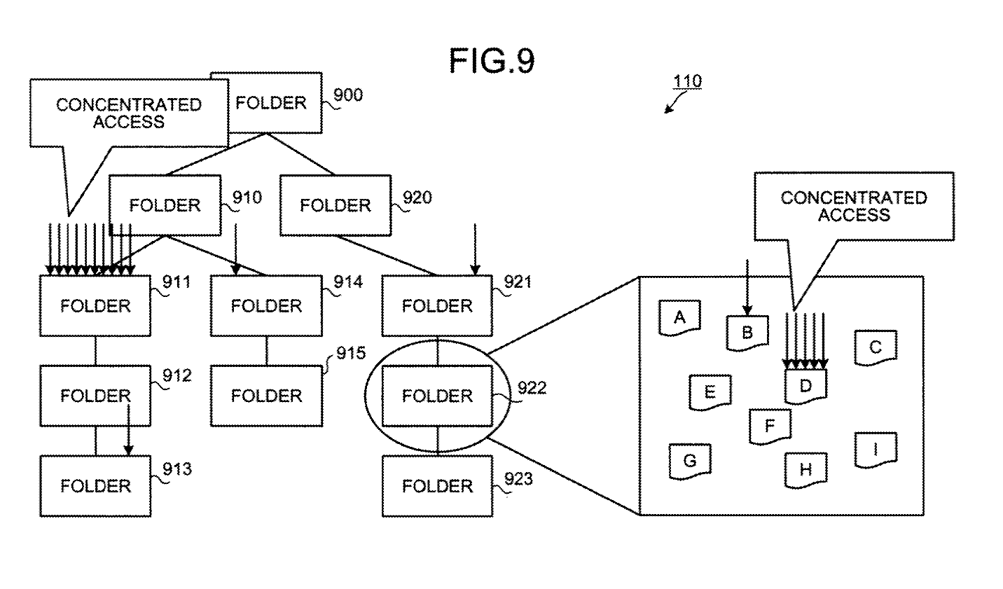

FIG. 9 is a diagram depicting an example of access concentration in the file server. In a folder 900 depicted in FIG. 9, two folders, folders 910, 920, have been created. Furthermore, in folder 910, two folders, folders 911, 914 have been created. Similarly, in folder 920, folder 921 has been created. In folder 911, folder 912 has been created; in folder 914, folder 915 has been created. In folder 912, folder 913 has been created. On the other hand, in folder 921, folder 922 has been created and in folder 922, folder 923 has been created.

In FIG. 9, arrows depicted above a folder or a file represents access count. In the case of the route of folders in folder 900 in FIG. 9 as a series of folders, there is a bias in the access by the apparatus 120. For example, access concentrates at folder 911. Further, in folder 922 in FIG. 9, nine files, files A to I, have been created. Even among the files created in the same folder 922, access concentrates at a given file, file D.

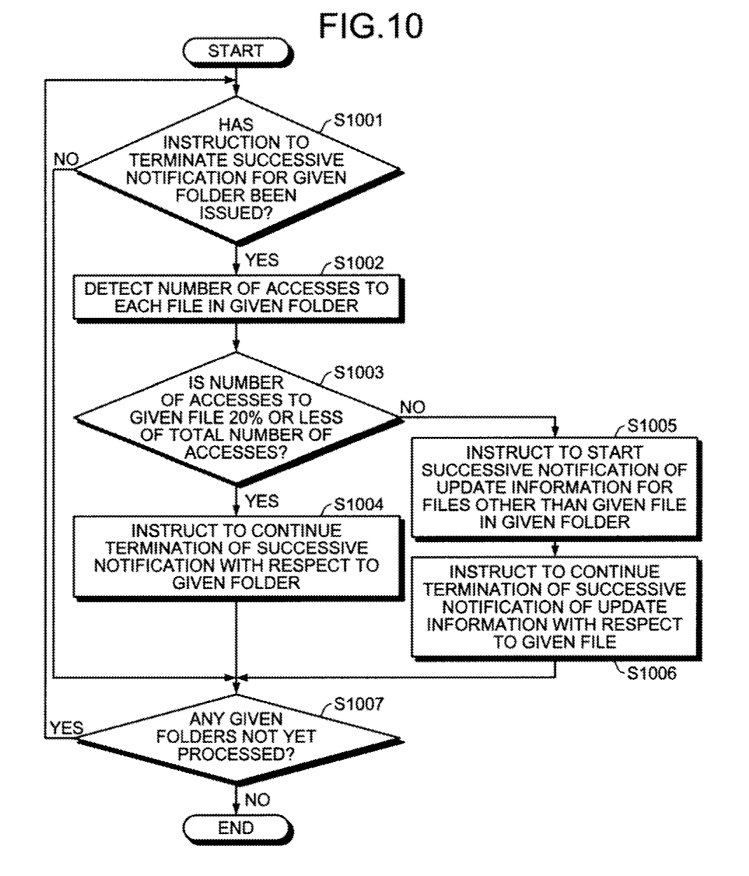

As depicted in FIG. 9, even among folders belonging to the same folder, folder 900, a situation in which access concentrates at only a given folder, at the same file, etc. occurs frequently. If access concentrates at a given folder or at the same file alone, the management apparatus 100 determines that access is concentrating comprehensively among other folders as well. Thus, the management apparatus 100, through the processes depicted in FIG. 10 and described next, can extract folders and files at which access is concentrating and independently set a survey target.

FIG. 10 is a flowchart of a procedure of setting a survey target. In FIG. 10, the management apparatus 100 first determines whether an instruction to terminate successive notification has been issued for a given folder (step S1001). Step S1001 is a process of determining whether a folder requiring survey-target setting processing is present. At step S1001, if it is determined that an instruction to terminate successive notification for the given folder has not be issued (step S1001: NO), the management apparatus 100 transitions to the process at step S1007, without performing any other process.

At step S1001, if it has been determined that an instruction to terminate successive notification for the given folder has been issued (step S1001: YES), the management apparatus 100 detects an access count for each file in the given folder (step S1002). The management apparatus 100, among the access counts detected at step S1002, determines whether the access count for a given file is at most 20 percent of the total number of accesses (step S1003).

Step S1003 is a process of determining whether access is concentrating at a given file. At step S1003, if it is determined that the access count for the given file is 20 percent or less of the total access count (step S1003: YES), the management apparatus 100 determines that access is not concentrating at the given file. Therefore, the management apparatus 100 issues an instruction to continue termination of the successive notification of the update information with respect to the given folder (step S1004). In other words, the state of terminating the successive notification currently set in the file server is continued.

On the other hand, at step S1003, if it is determined that the access count for the given file is not 20 percent or less of the total access count (step S1003: NO), the management apparatus 100 determines that access is concentrating at the given file. Therefore, the management apparatus 100 issues an instruction to start successive notification of the update information for files other than the given file in the given folder (step S1005).

The management apparatus 100 issues an instruction to continue to terminate successive notification of update information with respect to the given file (step S1006). By executing the processes at steps S1005, S1006, concerning update information for files (in the given folder in the file server) other than the given file where access is concentrating, the management apparatus 100 can perform control to successively give notification upon each access.

Subsequently, the management apparatus 100 determines whether a given folder that has yet to be processed is present (step S1007). A given folder that has yet to be processed is a folder for which access frequency has been determined high and is among the folders created in the file server.

At step S1007, if it is determined that a given folder that has yet to be processed is present (step S1007: YES), the management apparatus 100 returns to the process at step S1001 and performs the processes at steps S1001 to S1006 with respect to the given folder that has yet to be processed. Thereafter, at step S1007, if it is determined that no given folder that has yet to be processed is present (step S1007: NO), the management apparatus 100 ends the series of processes.

As described with reference to FIG. 10, the management apparatus 100 extracts a location, at the folder or file level, where access is concentrating and can set the location as a survey target. Therefore, since batch acquisition is performed only for a folder or a file where access is concentrating, for other folders and files where access is low, an information acquisition process according to the access frequency can be performed.

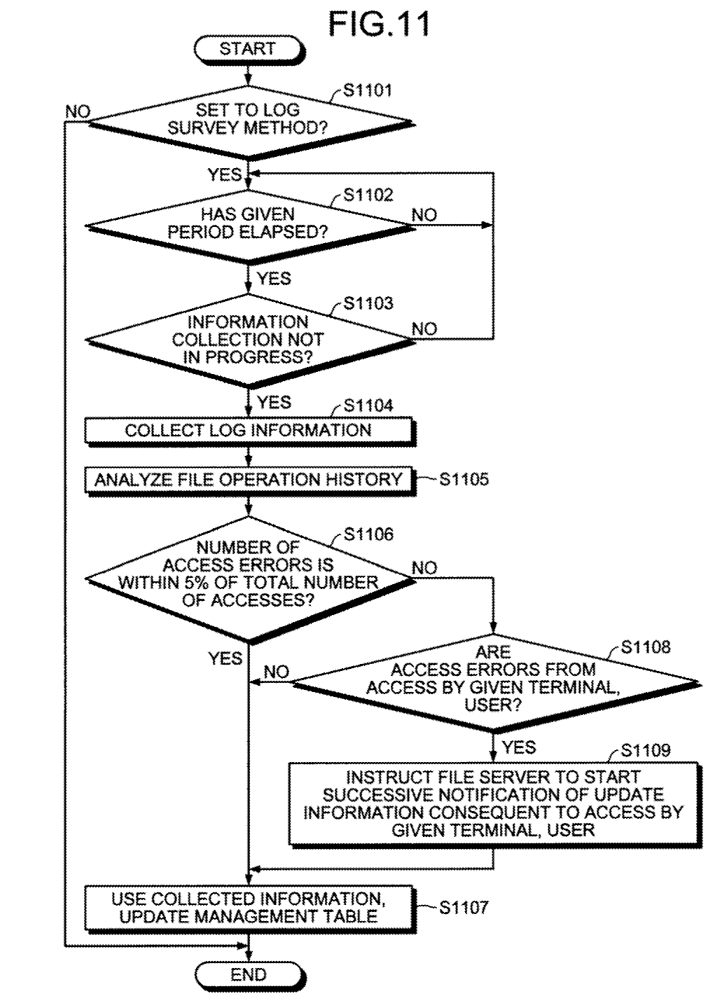

FIG. 11 is a flowchart of a procedure of a log survey process. The flowchart in FIG. 11 depicts a procedure where the management apparatus 100 acquires update information from the file server via a log survey scheme and updates the management table 101. By executing each process in FIG. 11, the update information indicating access particulars for the file server can be acquired collectively.

In FIG. 11, first, the management apparatus 100 determines whether the log survey scheme has been set in the file server (step S1101). At step S1101, if it is determined that the log survey scheme has been set (step S1101: YES), the management apparatus 100 determines whether a given period has elapsed since the setting of the log survey scheme (step S1102). At step S1101, if it is determined that the log survey scheme has not been set (step S1101: NO), the management apparatus 100 ends the series of processes.

At step S1102, the management apparatus 100 waits until the given period has elapsed (step S1102: NO). Upon elapse of the given period (step S1102: YES), the management apparatus 100 determines whether information is being collected from the file server (information collection in progress) (step S1103). At step S1103, information collection in progress means a state in which the management apparatus 100 is in the process of acquiring, from the log information 111 accumulated in the file server, update information that indicates access particulars.

At step S1103, various methods for the management apparatus 100 to determine whether information collection from the file server is in progress can be given. For example, one method is for the management apparatus 100 to refer to information that indicates the state of access of the file server. Another method may be used where a data table is prepared that indicates the operation state of the management apparatus 100 with respect to the file server. In this case, in determining whether information collection from the file server is in progress, the management apparatus 100 may refer to the data table. At step S1103, if it is determined that information collection is in progress (step S1103: NO), the management apparatus 100, again, performs the determination at step S1102.

At step S1103, if it is determined that information collection is not in progress (step S1103: YES), the management apparatus 100 collects the log information 111 from the file server (step S1104). The management apparatus 100 refers to the log information 111 collected at step S1104 and analyzes the file operation history (step S1105). Results of the analysis of the file operation history obtained at step S1105 are used to identify file errors.

Thereafter, from the analysis results at step S1105, the management apparatus 100 determines whether the access error count is within 5 percent of the total access count (step S1106). At step S1106, if it is determined that access error count is within 5 percent of the total access count (step S1106: YES), the management apparatus 100, using the log information 111 collected at step S1104, updates the management table 101 (step S1107). Although at step S1106, a determination criterion of “the access error count being within 5 percent of the total access count” is given, for example, a specific value such as “the access error count is within 100” may be set.

At step S1106, if it is determined that the access error count is not within 5 percent of the total access count (step S1106: NO), the management apparatus 100 further determines whether the access errors are from a given terminal/user. (step S1108). At step S1108, the management apparatus 100 determines whether the cause of the access errors is from access by the same terminal/from access by the same user.

At step S1108, if it is determined that the access errors are from access by a given terminal/user (step S1108: YES), the management apparatus 100 determines that the cause of the access errors lies with the given terminal or user. Therefore, the management apparatus 100 instructs the file server to start successive notification of the update information for access by the given terminal/user (step S1109).

At step S1108, if it is determined that the access errors are not from access by the given terminal/user (step S1108: NO), the management apparatus 100 transitions to the process at step S1107. Thereafter, the management apparatus 100, using the log information 111 acquired at step S1104, updates the management table 101 (step S1107), and ends the series of processes.

As described with reference to FIG. 11, if the log survey scheme is set, the management apparatus 100, for each monitoring interval, acquires the log information 111 by batch acquisition. If the access errors do not reach a given value (for example, within 5 percent of the total access count), concerning access causing access errors, the management apparatus 100 performs settings so that the file server performs successive notification. Therefore, the management apparatus 100 can independently monitor accesses seeming to cause the access errors.

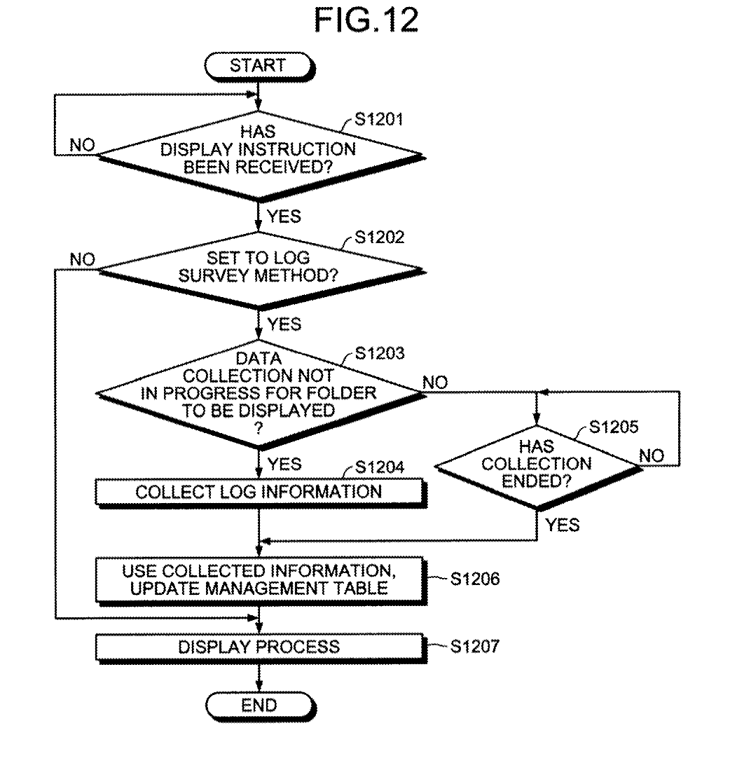

FIG. 12 is a flowchart of a procedure of a state displaying process. The flowchart in FIG. 12 depicts a process up to the display of information recorded in the management table 101, the display being in response to a display instruction for the management table 101 received from the user or an upper level program, by the management apparatus 100. By executing each of the processes in FIG. 12, the management apparatus 100 can display the latest updated contents reflecting the update information indicating the accesses occurring up to the receipt of the display instruction.

In FIG. 12, first, the management apparatus 100 determines whether a display instruction has been received from the user or an upper level program for the display of contents of the management table 101 (step S1201). The management apparatus 100, at step S1201, waits until a display instruction is received (step S1201: NO). Upon receipt of a display instruction (step S1201: YES), the management apparatus 100 determines whether the log survey scheme is currently set (step S1202).

At step S1202, if it is determined that the log survey scheme has been set (step S1202: YES), the management apparatus 100 performs a process for reflecting the latest access particulars concerning the information to be displayed.

Therefore, first, the management apparatus 100 determines whether information collection is in progress for the folder to be displayed (step S1203). At step S1203, information collection in progress means a state in which the management apparatus 100 is in the process of acquiring, from the log information accumulated in the file server, update information that indicates access particulars. In other words, if information collection is in progress, after the information collection is completed, the management table 101 will reflect the latest updated contents.

At step S1203, if it is determined that information collection is not in progress (step S1203: YES), the management apparatus 100 collects the log information 111 from the file server (step S1204). On the other hand, at step S1203, if it is determined that information collection is in progress (step S1203: NO), the management apparatus 100 determines whether the information collection currently in progress has ended (step S1205). At step S1203, the management apparatus 100 performs the same method as that at step S1103 to determine whether the information collection currently in progress from the file server has ended.

The management apparatus 100, at step S1205, waits until the information collection is completed (step S1205: NO). Upon completion of the information collection (step S1205: YES), the management apparatus 100 transitions to the process at step S1206.

The management apparatus 100, using the collected information, updates the management table 101 (step S1206). Depending on the processes that have transpired, the information that the management apparatus 100 uses for the update process at step S1206, differs.

For example, if it is determined at step S1203 that information collection is not in progress, the management apparatus 100 collects the log information 111 by the process at step S1204. Therefore, at step S1206, the management apparatus 100 uses the log information 111 collected by step S1204 to update the management table 101.

At step S1203, if it is determined that information collection is in progress, the management apparatus 100 is in the process of collecting information, at the time of determination at step S1203. Subsequently, the information collection is completed at step S1205. Therefore, at step S1206, the management apparatus 100 uses the log information 111 collected at step S1205 to update the management table 101.

At step S1202, if it is determined that the log survey scheme is not set (step S1202: NO), the management apparatus 100 acquires new update information, for each access. In other words, since the latest update state is reflected in the management table 101, the management apparatus 100 transitions to the process at step S1207. Finally, the management apparatus 100 performs display processing for the management table 101 in response to the display instruction (step S1207), and ends the series of processes.

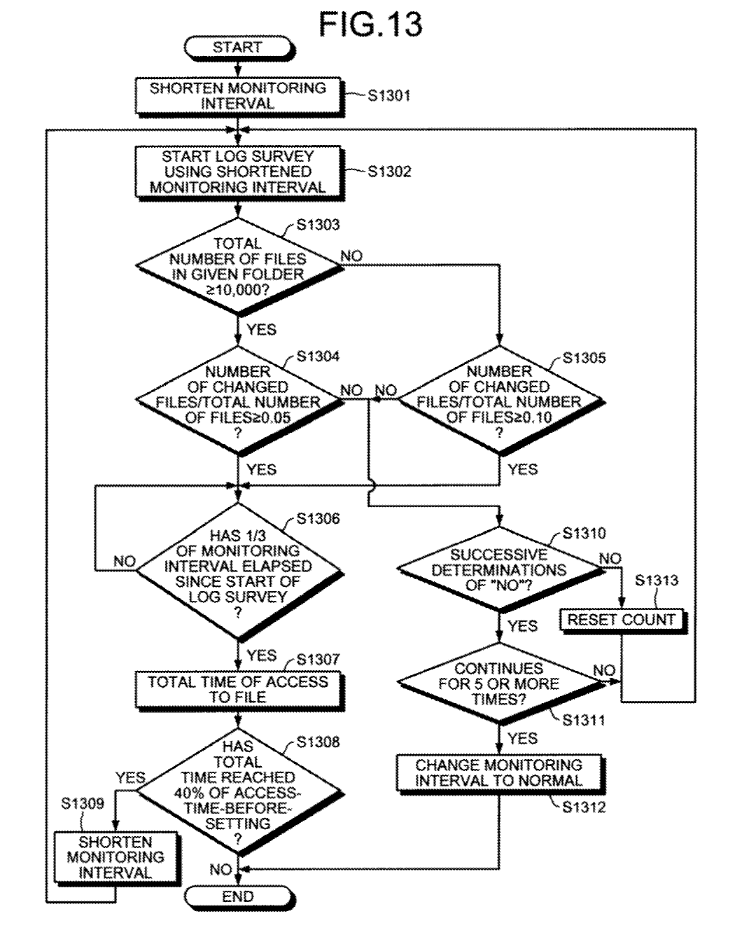

FIG. 13 is a flowchart of a procedure of adjusting a surveying interval. The flowchart in FIG. 13 depicts a procedure of adjusting the length of the surveying interval, according to the access count of the monitoring interval. By executing each of the processes in FIG. 13, the number of blocks of the log information 111 obtained for each monitoring interval are equalized.

In FIG. 13, the management apparatus 100 starts the process, triggered by an adjustment instruction that is from the user or an upper level program and instructs adjustment of the surveying interval. First, the management apparatus 100 shortens the monitoring interval currently set (step S1301). At step S1301, the management apparatus 100 shortens monitoring interval, based on a given criterion. For example, various criteria are set, such as set to ½ time of currently set time, shorten by X hours, etc. Here, as one example, a case is described where the current monitoring interval is set as 24 hours, and at the process at step S1301, is shortened to 12 hours, ½ the time.

The management apparatus 100 starts the log survey using the shortened monitoring interval (step S1302). By the process at step S1301, the monitoring interval of the management apparatus 100 has been shortened to 12. The management apparatus 100 determines whether the total file count for the folder under test is at least 10,000 (step S1303).

At step S1303, if it is determined that the total file count for the folder is 10000 or more (step S1303: YES), the management apparatus 100 determines whether the updated file count occupies at least 0.05 of the total file count (i.e., at least 5 percent of the total file count) (step S1304). Further, at step S1303, if it is determined that the total file count for the folder is not 10,000 or more (step S1303: NO), the management apparatus 100 determines whether the updated file count occupies at least 0.10 of the total file count (i.e., at least 10 percent of the total file count) (step S1305).

At step S1304, if it is determined that the updated file count occupies 0.05 or more of the total file count (step S1304: YES), the management apparatus 100 determines whether ⅓ of the monitoring interval has elapsed since the start of the log survey (step S1306). At step S1305, if it is determined that the updated file count occupies 0.10 or more of the total file count (step S1305: YES), the management apparatus 100 performs the determination at step S1306.

The management apparatus 100, at step S1301, sets the monitoring interval to 12 hours. Therefore, at step S1306, the management apparatus 100 determines whether 4 hours have elapsed since the start of the log survey. The determination criterion at step S1306 may be changed according to the setting of the monitoring interval. For example, if the monitoring interval is set to a value between 3 to 10 hours, the management apparatus 100 may determine whether a specified period has elapsed (e.g., 1 hour) since the start of the log survey.

The management apparatus 100, at step S1306, waits until it is determined that ⅓ of the monitoring interval has elapsed since the start of the log survey (step S1306: NO). Upon determination that ⅓ of the monitoring interval has elapsed since the start of the log survey (step S1306: YES), the management apparatus 100 sums the access time to the file from the start of the log survey to the present (step S1307).

The management apparatus 100 determines whether the time summed at step S1307 has reached 40 percent of the access-time-before-setting (step S1308). The access-time-before-setting is the monitoring interval prior to being newly shortened at step S1301. Therefore, at step S1308, the management apparatus 100 compares the access time that the apparatus 110 is accessed by the apparatus 120, obtained when log survey is performed using the 24-hour monitoring interval, and the access time from the start of the log survey at step S1302 until the present.

At step S1308, if it is determined that the summed time has reached 40 percent of the access-time-before-setting (step S1308: YES), the management apparatus 100 determines that the access frequency is too high to perform the log survey at the monitoring interval currently set. Therefore, the management apparatus 100 shortens the monitoring interval (step S1309). Thereafter, the management apparatus 100 returns to step S1302, and starts the log survey using the shortening monitoring interval (step S1302).

On the other hand, at step S1308, if it is determined that the summed time has not reached 40 percent of the access-time-before-setting (step S1308: NO), the management apparatus 100 determines that the monitoring interval currently set is appropriate. Therefore, the management apparatus 100 ends the series of processes.

At step S1304, if it is determined that the updated file count does not occupy 0.05 or more of the total file count (step S1304: NO), the management apparatus 100 determines whether NO has been determined successively at steps S1304 or step S1305 (step S1310). Similarly, at step S1305, if it is determined that the updated file count does not occupy 0.10 or more of the total file count (step S1305: NO), the management apparatus 100 performs the determination at step S1310.

At step S1310, if it is determined that NO has been determined successively (step S1310: YES), the management apparatus 100 further determines whether NO has been determined at least 5 successive times (step S1311). At step S1311, if it has been determined that NO has been determined 5 or more times (step S1311: YES), the management apparatus 100 determines that the monitoring interval currently set is too short. Therefore, the management apparatus 100 changes the monitoring interval to a normal setting (step S1312), and ends the series of processes.

At step S1310, if it is determined that NO has not be determined successively (step S1310: NO), the management apparatus 100 resets the count (step S1313), and returns to the process at step S1302. Furthermore, at step S1311, if it is determined that NO has not been determined 5 successive times or more (step S1311: NO), the management apparatus 100 returns to the process at step S1302. In other words, if determinations of NO are not successive, or if there are not 5 or more successive determinations of NO, the monitoring interval currently set is maintained.

As described, according to the embodiment, based on the access frequency of the apparatus 110, the information acquisition process for update information can be changed from independent acquisition to batch acquisition, or from batch acquisition to independent acquisition. Therefore, even access by the apparatus 120 concentrates, the management apparatus 100 can reduced the process load for managing the updating state, enabling decreases in processing performance to be prevented.

Further, in the embodiment, based on whether the access count per unit time is less than a threshold, an increase or a decrease in the access frequency is detected. Therefore, the management apparatus 100, irrespective of access state of the system using the apparatus 110, can detect changes in the proper access frequency.

Further, in the embodiment, the access frequency is detected for each folder and/or file in an accessed apparatus and any one among independent acquisition and batch acquisition can be set for each folder and/or file. Therefore, even if access concentrates at a given folder and/or at the same file, for locations where access is concentrated and locations where access is not concentrated, update information can be acquired for each access.

Moreover, in the embodiment, if batch acquisition has been set, until changed to independent acquisition, batch acquisition is executed at each specified given interval. Therefore, the management apparatus 100 can periodically acquire update information, without dependency on the time of access.

Also, in the embodiment, if batch acquisition has been set, upon receipt of an output instruction from an external device, even if the interval for executing batch acquisition has not come, batch acquisition is performed immediately. Therefore, updated contents reflecting the latest access can be output.

In the embodiment, if batch acquisition is performed, the interval for executing batch acquisition can be adjusted according to the access count. Therefore, biases in the number of blocks of update information acquired by batch acquisition are prevented, enabling decreases in the speed of management processing to be prevented.

The management method described in the present embodiment may be implemented by executing a prepared program on a computer such as a personal computer and a workstation. The program is stored on a non-transitory, computer-readable medium such as a hard disk, a flexible disk, a CD-ROM, an MO, and a DVD, read out from the recording medium, and executed by the computer. The program may be a transmission medium that can be distributed through a network such as the Internet.

The management apparatus 100 described in the present embodiments can be realized by an application specific integrated circuit (ASIC) such as a standard cell or a structured ASIC, or a programmable logic device (PLD) such as a field-programmable gate array (FPGA). For example, functional units (the detecting unit 401 to the output unit 409 of the management apparatus 100 are defined in hardware description language (HDL), which is logically synthesized and applied to the ASIC, the PLD, etc., thereby enabling manufacture of the management apparatus 100.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable, non-transitory medium storing therein a management program that causes a computer to execute a procedure, the procedure comprising:
detecting an increase in frequency of an access from a second apparatus to a first apparatus;
changing a first processing method for acquiring information indicating access particulars from the first apparatus when an access of the first apparatus by the second apparatus occurs, to a second processing method for collectively acquiring the information indicating access particulars from the first apparatus when an increase in the access frequency is detected at the detecting; and
acquiring the information collectively according to the second processing method after the first processing method is changed to the second processing method at the changing.

2. The computer-readable, non-transitory medium according to claim 1, wherein
the detecting includes detecting a decrease in the access frequency of the first apparatus by the second apparatus,
the changing includes changing the second process to the first process after the information has been acquired according to the second process, when a decrease in the access frequency is detected at the detecting while the second process is operated, and
the acquiring includes acquiring the information according to the first process when the second process has been changed to the first process at the changing.

3. The computer-readable, non-transitory medium according to claim 1, the procedure further comprising:
identifying an access count per unit time for access of the first apparatus by the second apparatus; and
determining whether the access count identified at the identifying is less than a threshold or not, wherein
the detecting includes detecting an increase in the access frequency of the first apparatus by the second apparatus, when the access count is determined to not be less than the threshold at the determining.

4. The computer-readable, non-transitory medium according to claim 2, the procedure further comprising:
identifying an access count per unit time for access of the first apparatus by the second apparatus; and
determining whether the access count identified at the identifying is less than a threshold, wherein
the detecting includes detecting a decrease in the access frequency of the first apparatus by the second apparatus, when the access count is determined to be less than the threshold at the determining.

5. The computer-readable, non-transitory medium according to claim 1, wherein
the detecting includes detecting, for each folder in the first apparatus, an increase in the access frequency, and
the changing includes changing the first process to the second process with respect to each folder in which an increase in the access frequency is detected.

6. The computer-readable, non-transitory medium according to claim 1, wherein
the detecting includes detecting, for each file in the first apparatus, an increase in the access frequency, and
the changing includes changing the first process to the second process with respect to each folder in which an increase in the access frequency is detected.

7. The computer-readable, non-transitory medium according to claim 1, wherein
the second process includes collectively acquiring for each given interval that elapses after a change to the second process at the changing, the information indicating access particulars for each access occurring during the given interval elapsed.

8. The computer-readable, non-transitory medium according to claim 1, wherein
when an instruction instructing output of the information indicating access particulars is received after a process is changed to the second process at the changing, the information indicating access particulars for each access occurred since the change to the second process until the receipt of the instruction is acquired according to the second process.

9. The computer-readable, non-transitory medium according to claim 7, the procedure further comprising:
counting the number of blocks of information included in the information acquired according to the second process; and
adjusting the length of the given interval based on the number of blocks of information counted at the counting.

10. The computer-readable, non-transitory medium according to claim 8, the procedure further comprising:
counting the number of blocks of information included in the information acquired according to the second process; and
adjusting the length of the given interval based on the number of blocks of information counted at the counting.

11. The computer-readable, non-transitory medium according to claim 9, wherein the adjusting includes shortening the length of the given interval, if the number of blocks of information counted at the counting is equal to or more than a given number.

12. The computer-readable, non-transitory medium according to claim 10, wherein the adjusting includes shortening the length of the given interval, if the number of blocks of information counted at the counting is equal to or more than a given number.

13. The computer-readable, non-transitory medium according to claim 9, wherein
the counting includes counting, for each given interval, the number of blocks of information included in the information acquired according to the second process, and
the adjusting includes increasing the length of the given interval subsequent to consecutive given intervals for which the counted number of blocks of information is less than the given number.

14. The computer-readable, non-transitory medium according to claim 10, wherein
the counting includes counting, for each given interval, the number of blocks of information included in the information acquired according to the second process, and
the adjusting includes increasing the length of the given interval subsequent to consecutive given intervals for which the counted number of blocks of information is less than the given number.

15. A management apparatus comprising:
a detecting unit that detects an increase in access frequency of a first apparatus by a second apparatus;
a changing unit that changes a first process of acquiring from the first apparatus and independently for each access of the first apparatus by the second apparatus, information indicating access particulars, to a second process of collectively acquiring from the first apparatus, the information indicating access particulars, if an increase in the access frequency is detected by the detecting unit; and
an acquiring unit that acquires the information indicating access particulars, where the information indicating access particulars is acquired independently according to the first process, and is acquired collectively according to the second process, after the first process is changed to the second process by the changing unit.

16. A management method executed by a computer, the method comprising:
detecting an increase in access frequency of a first apparatus by a second apparatus;
changing a first process of acquiring from the first apparatus and independently for each access of the first apparatus by the second apparatus, information indicating access particulars, to a second process of collectively acquiring from the first apparatus, the information indicating access particulars, if an increase in the access frequency is detected at the detecting; and
acquiring the information indicating access particulars, where the information indicating access particulars is acquired independently according to the first process, and is acquired collectively according to the second process, after the first process is changed to the second process at the changing.
